(19) United States
(12) Patent Application Publication
(10) Pub. No.: US 2016/0221519 A1
(43) Pub. Date: Aug. 4, 2016

(54) CARBON GLASS FIBER PULTRUSSION BUMPER BEAMS

(71) Applicant: GM Global Technology Operations LLC, Detroit, MI (US)

(72) Inventor: Christopher G. Basela, Ortonville, MI (US)

(21) Appl. No.: 14/611,793

(22) Filed: Feb. 2, 2015

(51) Int. Cl. B60R 19/03; B32B 17/06; B32B 9/02; B32B 15/04; B29C 70/52; B32B 27/06; B32B 27/34; B32B 27/36; B32B 27/32; B32B 3/26; B32B 21/04

(52) U.S. Cl. CPC B60R 19/03; B32B 3/266; B32B 17/064; B32B 17/06; B32B 17/061; B32B 17/062; B32B 9/02; B32B 15/04; B32B 21/04; B32B 27/06; B32B 27/34; B32B 27/36; B32B 27/32; B29C 70/52; B32B 2250/02; B32B 2605/00; B29L 2031/3044

(57) ABSTRACT

A number of variations may include a structural member and a method of manufacture thereof wherein the structural member may be comprised of a core, a shell, and a bonding agent. At least one of the shell or the core may comprise a pultruded material which may comprise carbon.

### TECHNICAL FIELD

The field to which the disclosure generally relates to includes automotive components including but not limited to materials used in vehicle frames and/or structures.

### BACKGROUND

Some automotive frames or structures may be formed from metal.

### SUMMARY OF ILLUSTRATIVE VARIATIONS

One variation of the invention may include a product which may include a shell and a core. The shell may at least partially overlay the core. Moreover, at least one of the shell or the core may comprise a protruded material.

Another variation of the present invention may include a process which may include providing a shell and a core and pultruding at least one of the shell or the core through a bonding agent. At least a portion of the bonding agent may be in contact with the shell or the core. At least a portion of the shell may be positioned over at least a portion of the core. Finally, the core and the shell may be cured in order to form a structural member. The structural member may be an automotive structural element.

Another variation of the present invention may include a method of producing a front bumper beam, a rear bumper beam, or a side impact beam which may include first providing a shell and a core. At least one of the shell or the core may be pultruded through a bonding agent. At least a portion of the bonding agent may be in contact with the shell or the core. At least a portion of the shell may be positioned over at least a portion of the core. Finally, the core and the shell may be cured in order to form a structural member. At least one of the shell or the core may include carbon.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a perspective view of one variation of a structural member;

FIG. 2 is a perspective view of one variation of the structural member;

FIG. 3 is a perspective view of one variation of the structural member; and

FIG. 4 is a cross-sectional view of one variation of the structural member.

### DETAILED DESCRIPTION OF ILLUSTRATIVE VARIATIONS

The following description of the variations is merely illustrative in nature and is in no way intended to limit the scope of the invention, its application, or uses.

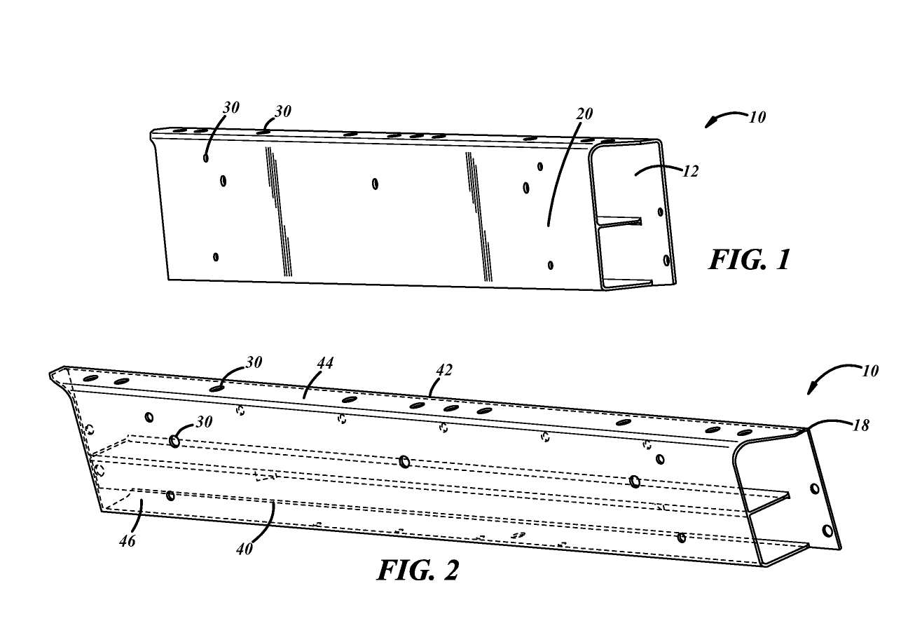

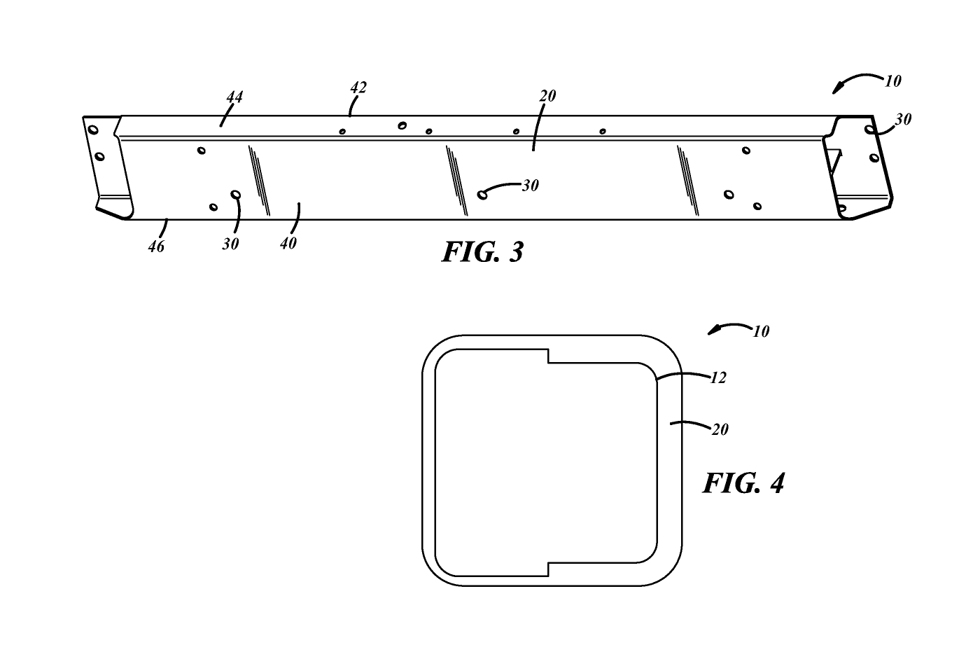

Referring now to the variation shown in FIG. 1, a structural member 10 may be provided. The structural member 10 may be used in such applications as front or rear bumpers, side impact beam, vehicle frames, beams, springs, or various other structures used in vehicles and additionally may be used in other applications. The structural member 10 may provide a high strength mass ratio in relation to other materials such as steel or other metals. It is contemplated that the structural member 10 may additionally or alternatively provide a spring back effect which may enable the structural member to return to its original shape after an impact.

Referring now to the variation illustrated in FIG. 2, the structural member 10 may include a core 12. The core 12 may comprise a plurality of fibers 14. The fibers 14 may be natural, synthetic, textile or of any other type as known by one of ordinary skill in the art. The fibers 14 may additionally include animal, mineral or vegetable fibers which may include but are not limited to alpaca, angora, byssus, camel hair, cashmere, catgut, chiengora, guanaco, llama, mohair, pashmina, qiviut, rabbit, silk, sinew, spider silk, wool, vicuna, yak, abaca, bagasse, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic aramid, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber-reinforced thermoplastic, carbon nanotube reinforced polymer, fiber reinforced polymer, fiberglass (including E-glass, A-glass, E-CR glass, C-glass, D-glass, R-glass, S-glass or any other type), basalt, aluminum, or maybe an additional fiber as known by one of ordinary skill in the art. It is contemplated that the core 12 may contain any combination of the above list in various concentrations. Additionally, it is contemplated that the components of the fiber 14 may be intermixed. Moreover, additional woven composite filament 16 may also be formed from the above components.

It is contemplated that the core 12 or the woven composite filament 16 may be formed as continuous filaments, in continuous mats, or by sheets. Additionally it is contemplated that the core 12 may be formed by an additional formation as known by one of ordinary skill in the art. Moreover, the core 12 maybe formed using various operations including but not limited to a hand lay-up operation, a spray lay-up operation, a pultrusion operation, a chopped strand mat, vacuum bag molding, pressure bag molding, autoclave molding, resin transfer molding, vacuum assisted resin transfer molding, bladder molding, compression molding, mandrel wrapping, wet lay-up, chopper gun, filament winding, melting, staple fiber, continuous filament or other operations as known by one of ordinary skill in the art.

Moreover, it is contemplated that the core 12 may be manufactured in a three dimensional orientation or in a two dimensional orientation. The core 12 may additionally include a short-fiber reinforced material or continuous-fiber reinforced material or may include another type of fiber. It is contemplated that the core 12 may be manufactured or woven through knitting, braiding, weaving, stitching, plain weaving, satin weaving, or another weaving method as known by one of ordinary skill in the art. It is additionally contemplated that the core 12 may be manufactured in a different process as known by one of ordinary skill in the art. It is contemplated that the core 12 may have various sizes and shapes including various widths, lengths and/or diameters of fibers as well as the core may have various shapes and sizes including various width, lengths and diameters in its overall dimensions. It is contemplated that at least a portion of the core 12 may be in contact with a bonding agent. The bonding agent may be coated, preimpregnated, or otherwise in contact with at least a portion of the core.

Referring now to the variation included in FIGS. 1 and 2, the structural member 10 may additionally include a shell 20. The shell may comprise a plurality of fibers 22. The fibers 22 may be natural, synthetic, textile or any other type as known by one of ordinary skill in the art. Moreover, the fibers 22 may include vegetable, animal or mineral fibers including but not limited to alpaca, angora, byssus, camel hair, cashmere, catgut, chiengora, guanaco, llama, mohair, pashmina, qiviut, rabbit, silk, sinew, spider silk, wool, vicuna, yak, abaca, bagasse, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic aramid, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber-reinforced thermoplastic, carbon nanotube reinforced polymer, fiber reinforced polymer, fiberglass (including E-glass, A-glass, E-CR glass, C-glass, D-glass, R-glass, S-glass or any other type), basalt, aluminum, or maybe an additional fiber as known by one of ordinary skill in the art. The shell 20 may include various combinations of the above fibers 22 in various concentrations. Additionally, the components may be intermixed. Additionally, it is contemplated that additional woven composite filament 24 may be formed from these components.

It is contemplated that the shell 20 may be formed by sheets, continuous mats, or as continuous filaments. Additionally, the shell 20 may be formed by any operation including but not limited to a hand layup operation, a spray layup operation, pultrusion operation, a chopped strand mat, vacuum bag molding, pressure bag molding, autoclave molding, resin transfer molding, vacuum assisted resin transfer molding, bladder molding, compression molding, mandrel wrapping, wet layup, chopper gun, filament winding, melting, staple fiber, continuous filament, or any other operation as known by one of ordinary skill in the art. Moreover, the shell may be manufactured in a 2-dimensional orientation or in a 3-dimensional orientation. The shell 20 may additionally include short fiber reinforced materials or continuous fiber reinforced materials or may additionally include any other type of reinforced materials. It is contemplated that the shell 20 may be manufactured or woven through knitting, braiding, weaving, stitching, plain weaving, satin weaving, or another weaving method as known by one of ordinary skill in the art. Moreover, the shell 20 may include various widths, lengths, thicknesses and/or diameters of fibers 22. Additionally, the shell 20 may be of various widths, lengths, thicknesses or diameters as well as any shape as desired by one of ordinary skill in the art. Additionally, at least a portion of the shell 20 may be preimpregnated, coated, or otherwise in contact with the bonding agent 18.

Referring again to FIG. 1, the structural member 10 may include at least one hole 30. The hole 30 may be machined or may be formed by any other process as known by one of ordinary skill in the art. The hole 30 may be defined as a see through opening on the side or within the structural member 10. The hole 30 may be of any shape and size including but not limited to circular, half circular, U-shaped, polygonal, triangular or any other shape.

It is contemplated that at least one insert may be positioned to be in contact with the hole 30. The insert may be constructed and arranged to attach the structural member to other components, braces, compartments or features of a vehicle. Additionally it is contemplated that the insert may be used in any other way as known by one of ordinary skill in the art. It is contemplated that the insert may act as a galvanic corrosion isolator to a body attachment point or as a fastener to a body attachment point and may allow for higher torque loading. It is contemplated that the insert may be of any shape and size including but not limited to a circle, half circle, an ellipse, a parabola, a triangle, a polygon, or any other shape.

It is contemplated that the insert may be comprised of steel, or other metal, a polymer, a textile, or any other material as known by one of ordinary skill in the art. For example, in one variation the insert may comprise a metal such as titanium, steel, cast iron, alloy steel, stainless steel, platinum, palladium, aluminum, copper, nickel, iron, lead, tin, cobalt, bronze or any other type of metal. In another variation, the insert may comprise a textile which may include an animal textile, a plant textile, or a synthetic textile. It is also contemplated that the insert may comprise a composite material. The composite material may include but is not limited to a fiber reinforced polymer, a thermoplastic composite, a metal matrix composite, a ceramic matrix composite, an organic matrix composite, a fiber reinforced composite, a polyester, a vinyl ester, an epoxy, a phenolic polymer, a polyimide polymer, a polyamide polymer, a polypropylene, PEEK or another type of material. It is also contemplated that the insert may be a pre machined insert may be pre machined through a stamp and roll or may be machined by another process as known by one of ordinary skill in the art. Moreover, the insert may include a bearing, including a plain bearing, a rolling-element bearing, a jewel bearing, a fluid bearing, a magnetic bearing, a flexure bearing, or may be any other type of bearing. In one variation, when the insert may be a plain bearing, the plain bearing may be integral type, bushing type, two-piece type, or any other type of plain bearing as known by one of ordinary skill in the art.

Referring again, to FIGS. 1 and 2, the bonding agent 18 may be held in contact with the core 12, the shell 20, or the insert. The contact between the bonding agent 18 and the core 12, shell 20, or insert may result in adherence or bonding between the bonding agent 18, the core 12, the shell 20, the insert, or any combination thereof. The bonding agent 18 may comprise urethane resin, vinylester resin, polyester resin, epoxy resin, phenolic resin, modified phenolic resin or any other type of bonding agent as known by one of ordinary skill in the art. Additionally, the bonding agent 18 may be a reactive bonding agent or a non-reactive bonding agent as desired by one of ordinary skill in the art.

The structural member 10 may be produced by various fabrication or manufacturing methods. The structural member 10 may be in a two or three dimensional orientation. The core 12, the shell 20, both, or neither may be manufactured or woven through weaving, knitting, braiding, stitching, plain weaving, satin weaving or may be manufactured in another way. In one variation, at least one of a weave, a knit, a braid, a stitch, a plain weave, or a satin weave can be added to the core 12, to the shell 20, or to both during manufacturing or fabrication. Additionally, the core 12, the shell 20, or both may be orientated at 90 degrees, 45 degrees, 60 degrees, or another angle as desired by one of ordinary skill in the art. In at least one variation, fibers 14, 22 in the core 12 or the shell 20 or both may be bundled prior to manufacture or may be bundled during manufacture. It is contemplated that the core 12 may be pultruded by a tension roller and additionally may be contacted with the bonding agent 18. It is also contemplated that the shell 20 may be pultruded by a tension roller and contacted with the bonding agent 18. It is additionally contemplated that both the core 12 and the shell 20 may be pultruded by a tension roller and additionally contacted with the bonding agent 18. The core 12, the shell 20 or both may be held in contact and cured in order to form the structural member 10. It is contemplated that the shell 20 may at least partially overlay the core 12. Additionally, it is contemplated that the core 12 and the shell 20 may be held together in contact by the tension roller.

In one variation, the core 12 and the shell 20 may be formed from pultrusion. The core 12 and the shell 20 may be pultruded from a molding head. It is contemplated that only one of or both the shell 12 and the core 20 may be pultruded through the molding head. Additionally it is contemplated in one variation that additional woven composite filament fibers may be added to either the core 12 or to the shell 20 or both. It is contemplated that a sweep may be added to the structural member 10 in order to form a desired shape prior to the structural member 10 being completely cured. The sweep may be of any level of degree as desired by one of ordinary skill in the art. Some examples of level of sweep include but are not limited to 90 degrees, 45 degrees, 60 degrees or any other degree as desired by one of ordinary skill in the art. Moreover, a sweep may be added through a curved track.

It is contemplated that the structural member 10 may be cut to a desired length in order to fit the desired application. The structural member 10 may be cut, machined, pierced or routered in order to form the desired shape and size of the structural member 10. Moreover, the at least one hole 30 may be formed in the structural member. It is contemplated that the hole 30 may be machined, cut, pierced or routered into the structural member. It is contemplated that the hole 30 may be located on any surface of the structural member.

It is contemplated that the structural member 10 may be finished with various other methods in order to produce a final design. For example, a mold may be tooled in order to form the desired shape or variation of the structural member 10 for its intended purpose. It is contemplated that the structural member 10 may contain a mass weight of approximately 45-50 percent carbon.

Referring again to the variation illustrated in FIG. 1, the structural member 10 may include at least a front face 40, a rear face 42, a top face 44, and a bottom face 46 along with the core 12. It is contemplated that the structural member 10 may be comprised of various layers of composite material as described above. It is contemplated that the front face 40 of the structural member 10 may include approximately 8 to 12 layers and may be approximately 1 to 3 millimeters thick. Additionally, it is contemplated that the rear face 42 of the structural member 10 may include 12 to 18 layers of composite material and may include a thickness of approximately 2 to 4 millimeters. Additionally, it is contemplated that the top face 44 of the structural member 10 may include 10 to 14 layers and may have a thickness of 2 to 3 millimeters. Moreover, the bottom face 46 of the structural member 10 may include approximately 12 to 16 layers and may have a thickness of approximately 2.5 to 3 millimeters. Additionally, it is contemplated that the core 12 may be comprised of multiple layers of composite material as described above. It is contemplated that the core 12 may include approximately 8 to 12 layers and may have a thickness of approximately 1.5 to 2.5 millimeters. Moreover, it is contemplated that the material orientation for any of the composite layers including but not limited to the front face 40 of the structural member, the rear face 42 of the structural member, the top face 44 of the structural member, the bottom face 46 of the structural member and/or the core 12 may have a material orientation of −45, 0, 45, or 90 in any combination as desired by one of ordinary skill in the art.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product which may include a shell and a core. The shell may at least partially overlay the core. Additionally, at least one of the shell or the core comprises a pultruded material.

Variation 2 may include a product as set forth in variation 1, wherein the product may be one of a front bumper beam, a rear bumper beam or a side impact beam.

Variation 3 may include the product as set forth in any of variation 1 to 2, wherein at least one hole may be formed in the product.

Variation 4 may include the product as set forth in any of variations 1 to 3, wherein at least one insert may be positioned in contact with the hole.

Variation 5 may include the product as set forth in any of variations 1 to 4, wherein the insert may include at least one of serrations, knearling, or an adhesive layer.

Variation 6 may include the product as set forth in any of variations 1 to 5, wherein the insert may comprise a metal which may include at least one of stainless steel or titanium.

Variation 7 may include the product as set forth in any of variations 1 to 6, wherein the core further comprises a pultruded material comprising glass.

Variation 8 may include the product as set forth in any of variations 1 to 7, wherein the shell may further comprise at least one fiber comprising at least one of alpaca, angora, byssus, camel hair, cashmere, catgut, chiengora, guanaco, llama, mohair, pashmina, qiviut, rabbit, silk, sinew, spider silk, wool, vicuna, yak, abaca’, bagasse, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass, basalt, or aluminum.

Variation 9 may include a process which may include providing a shell and a core along with pultruding at least one of the shell or the core through a bonding agent. At least a portion of the bonding agent may be in contact with the shell or the core. At least a portion of the shell may be positioned over at least a portion of the core. Finally, the core and shell may be cured in order to form a structural member. The structural member may be an automotive structural element.

Variation 10 may include the process as set forth in variation 9, wherein the structural member may be one of a front beam, a rear beam, or a side impact beam.

Variation 11 may include the process as set forth in any of variations 9 or 10, wherein at least one hole may be formed in the structural member.

Variation 12 may include the process as set forth in any of variation 11, wherein at least one insert may be positioned in contact with the hole.

Variation 13 may include the process as set forth in any of variations 10 to 12, wherein the insert comprises at least one of serrations, knearling, or an adhesive layer.

Variation 14 may include the process as set forth in any of variations 9 to 13, wherein the insert may comprise a metal comprising at least one of stainless steel or titanium.

Variation 15 may include a method of producing a front bumper beam, a rear bumper beam, or a side impact beam which may include first providing a shell and a core and then pultruding at least one of the shell or the core through a bonding agent. At least a portion of the bonding agent may be in contact with the shell or the core. At least a portion of the shell may be positioned over at least a portion of the core. Finally, the core and shell may be cured in order to form a structural member, wherein at least one of the shell or the core comprises carbon.

Variation 16 may include the process as set forth in variation 15, wherein at least one hole may be formed in the structural member.

Variation 17 may include the process as set forth in variation 15 or 16, wherein at least one insert may be positioned to be in contact with the hole.

Variation 18 may include the method as set forth in any of variations 15 to 17, wherein the bonding agent may comprise a resin comprising at least one of vinylester resin, polyester resin, epoxy resin, phenolic resin, or modified phenolic resin.

Variation 19 may include the method as set forth in any of variations 15 to 18, wherein the core may further comprise a pultruded material comprising glass.

Variation 20 may include the method as set forth in any of variations 15 to 19, wherein the shell may further comprise at least one fiber comprising at least one of alpaca, angora, byssus, camel hair, cashmere, catgut, chiengora, guanaco, llama, mohair, pashmina, qiviut, rabbit, silk, sinew, spider silk, wool, vicuna, yak, abaca’, bagasse, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass, basalt, or aluminum.

The above description of select variations within the scope of the invention is merely illustrative in nature and, thus, variations or variants thereof are not to be regarded as a departure from the spirit and scope of the invention.

What is claimed is:

1. A product comprising:
a shell;
a core wherein the shell at least partially overlays the core; and
wherein at least one of the shell or the core comprises a pultruded material.

2. The product of claim 1, wherein the product is one of a front bumper beam, a rear bumper beam, or a side impact beam.

3. The product of claim 1, wherein at least one hole is formed in the product.

4. The product of claim 3, wherein at least one insert is positioned in contact with the hole.

5. The product of claim 4, wherein the insert comprises at least one of serrations, knearling, or an adhesive layer.

6. The product of claim 4, wherein the insert comprises a metal comprising at least one of stainless steel or titanium.

7. The product of claim 1, wherein the core further comprises a pultruded material comprising glass.

8. The product of claim 7, wherein the shell further comprises at least one fiber comprising at least one alpaca, angora, byssus, camel hair, cashmere, catgut, chiengora, guanaco, llama, mohair, pashmina, qiviut, rabbit, silk, sinew, spider silk, wool, vicuna, yak, abaca’, bagasse, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass, basalt, or aluminum.

9. A process comprising:
providing a shell and a core;
pultruding at least one of the shell or the core through a bonding agent, wherein at least a portion of the bonding agent is in contact with the shell or the core;
positioning at least a portion of the shell over at least a portion of the core; and
curing the core and shell to form a structural member, wherein the structural member is an automotive structural element.

10. The process of claim 9, wherein the structural member is one of a front bumper beam, a rear bumper beam, or a side impact beam.

11. The process of claim 9, wherein at least one hole is formed in the structural member.

12. The process of claim 11, wherein at least one insert is positioned in contact with the hole.

13. The process of claim 12, wherein the insert comprises at least one of serrations, knearling, or an adhesive layer.

14. The process of claim 13, wherein the insert comprises a metal comprising at least one of stainless steel or titanium.

15. A method of producing a front bumper beam, a rear bumper beam, or a side impact beam comprising:
providing a shell and a core;
pultruding at least one of the shell or the core through a bonding agent, wherein at least a portion of the bonding agent is in contact with the shell or the core;
positioning at least a portion of the shell over at least a portion of the core; and
curing the core and shell to form a structural member, wherein at least one of the shell or the core comprises carbon.

16. The method of claim 15, wherein at least one hole is formed in the structural member.

17. The method of claim 16, wherein at least one insert is positioned to be in contact with the hole.

18. The method of claim 15, wherein the bonding agent comprises a resin comprising at least one of vinylester resin, polyester resin, epoxy resin, phenolic resin, or modified phenolic resin.

19. The method of claim 15, wherein the core further comprises a pultruded material comprising glass.

20. The method of claim 19, wherein the shell further comprises at least one fiber comprising at least one of alpaca, angora, byssus, camel hair, cashmere, catgut, chiengora, guanaco, llama, mohair, pashmina, qiviut, rabbit, silk, sinew, spider silk, wool, vicuna, yak, abaca’, bagasse, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass, basalt, or aluminum.
